(19) United States
(12) Patent Application Publication
(10) Pub. No.: US 2009/0082231 A1
(43) Pub. Date: Mar. 26, 2009

(54) METHOD OF PRODUCING PROPPANTS FROM GLASS SPHERES

(76) Inventors: Sergei Fedorovich Shmotiev, Ekaterinburg (RU); Sergei Yurievich Pliner, Ekaterinburg (RU)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/180,722

(22) Filed: Jul. 28, 2008

(30) Foreign Application Priority Data
Sep. 24, 2007 (RU) 2007135495

(51) Int. Cl. C09K 8/80

(52) U.S. Cl. 507/269

(57) ABSTRACT

The invention is directed to enhancement of the effectiveness of the proppant as a result of increasing its strength, providing high permeability of the layer of proppant in the well. This result is achieved in that in the method of producing proppant from glass spheres, comprising preparing a melt of oxides, with forming spheres and cooling them, additional retention of the prepared spheres is carried out at 870-1100° C. for 8-25 minutes to the formation of a glass crystalline structure. Wherein it is possible that the glass crystalline structure contains at least 40% crystalline phase, preparation of the melt is carried out by feeding glass powder in a gas stream, said cooling and retention are carried out in one thermal device, the method itself is carried out in a rotary furnace.

The invention relates to the oil and gas production industry, in particular to the production of proppants used as propping agents in the production of oil and gas by the method of hydraulic fracturing the formation.

In accordance with the international standard ISO 13053, the quality of a proppant is determined by such indexes as the sphericity and roundness, solubility in acids, apparent density, resistance to crushing. It is generally accepted that spherical granules of one size with high strength and smooth surface should have high permeability, i.e., under other equal conditions provide for an increase of the debit of oil and gas wells. Most widely used in the past were proppants which are natural balled sand. Sand has good acid resistance, is inexpensive, but its use is limited to wells that are not deep in view of the low strength, since large-crystal quartz grains have defective macrostructure. The sphericity and roundness of natural sands are also far from being excellent and in accordance with ISO 13053 do not exceed the value 0.7. In order to increase the sphericity and roundness of natural sand, it is covered with a film of phenol-formaldehyde resin with a thickness of 10-40 microns, which significantly increases the cost thereof, but the permeability insignificantly increases.

A proppant is known, which is glass microspheres, which have high sphericity and roundness, smooth surface (U.S. Pat. No. 3,497,008, 24 Feb. 1970). However, these microspheres have low mechanical strength and also low resistance to mud acid—a mixture of hydrochloric acid and hydrofluoric acid, and therefore the use thereof in wells subject to acid processing is not possible.

It is known that an increase in the quality of glass microspheres is provided by the conditions of the method of the production thereof, wherein a method of producing glass microspheres is known, consisting in preparing glass powder, feeding it into a forming furnace, forming glass microspheres in a high temperature gas stream, cooling them in a gas-air stream (RU No. 2081858, 20 Jun. 1997).

The most similar in respect to technical essence is the method of producing proppant from glass spheres, comprising preparing in a rotary furnace a melt of oxides, including in the form of glass powder, with the formation of glass spheres, cooling them with air to a temperature of 480-675° C. and feeding them to a cooling liquid—a starch solution, glycol. Wherein, the obtained spheres have a strength of more than 700 kg/cm², density less than 2.6 g/cm³, sphericity 0.84. resistance at a temperature of 1200° C. and pH 3-11 (see GB No. 1089213 of 1 Nov. 1967).

The technical object to the solution of which the invention is directed is enhancement of the effectiveness of the proppant by increasing the strength thereof, providing high permeability of the proppant layer in the well.

This result is achieved in that in the method of producing proppant from glass spheres, comprising preparing an oxide melt with forming spheres and cooling them, the obtained spheres are additionally retained at 870-1100° C. for 8-25 minutes to the formation of a glass-crystalline structure. Wherein it is possible that the glass-crystalline structure comprises not less than 40% crystalline phase, preparation of the indicated melt is carried out by feeding glass powder in a gas stream, the aforesaid cooling and retention are carried out in one thermal device, the method itself is carried out in a rotary furnace.

The preparation of a homogeneous melt is carried out from oxides of the group SiO₂, MgO, CaO, Al₂O₃, FeO, Fe₂O₃, Na₂O, K₂O, P₂O₅, TiO₂, Cr₂O₃, B₂O₃.

A specificity of the proposed method as compared with the technology of traditional glassceramics is the use of compositions with a substantially less content of the glass-forming oxides—SiO₂, B₂O and P₂O₅ and the close approach to the composition of compounds that crystallize upon thermal treatment. This makes it possible to carry out thermal treatment with crystallization of the necessary compounds in the course of minutes, not hours as is the case with glass ceramics. On the other hand, in traditional technology of glass ceramics, the use of the proposed composition is difficult since rapid cooling of the articles results in the destruction thereof, while proppants because of their small size and spherical form are not subjected to destruction even at cooling speeds up to 600°/sec. As distinctive from silica-alumina materials with a high content of Al₂O₃, which crystallize below the melting point, the proppant prepared according to the proposed method, solidifies in the form of glass over a broad range of temperature.

The advantages of the proposed method are the following:

upon melting the components, a homogeneous melt is formed, which is virtually impossible to achieve by sintering powder materials;

upon the formation from a melt, the drop due to surface tension acquires an “ideal” spherical shape with a smooth surface;

thermal treatment of the glass spheres takes place at significantly lower temperatures than sintering ceramics of the same composition, and therefore crystallization is accompanied by the formation of extremely small crystals (less than 1 micron). Such a structure of the proppants may be achieved only upon use of nano size powders;

upon the formation of a proppant body from a melt, such defects as open porosity and granulation defects are not observed, while upon the dissolution of gaseous compounds in the melt, proppants are formed in the form of hollow spheres that are an attraction for consumers as a result of less apparent density.

Thermal treatment of the cooled spherical drops is carried out according to the temperature regimen and for a length of time providing a transition of at least 40% of the glass phase into a crystalline, since in the presence of a continuous phase of the glass, the strength and acid resistance are determined by the glass phase, and the glass proppants have low operational characteristics. Devitrification of the glass phase upon thermal treatment may be complete, but this requires more lengthy regimens (to one hour) or increased temperatures resulting in a growth of the crystals and a reduction of the mechanical strength of the proppant.

Economically, it is more justified to use oxides of silica, magnesium, calcium, aluminum, iron, sodium, potassium, phosphorus, titanium, chrome, boron for production of the proppants in accordance with the proposed method, but the preparation of glass-crystalline proppants is technically possible upon insertion into the glass oxides of lithium, sulfur, zirconium, zinc, barium, beryllium, rare earth elements, and also fluoride, chloride, sulfides, nitrides, carbides and other compounds and elements, including copper, silver and gold.

### EXAMPLE 1

The mixture consisting of dolomite, quartz, feldspar and apatite were cooked in a pot glass furnace at a temperature of 1350° C. The obtained glass had the following chemical composition: SiO₂—45.9%; CaO—29.0%; MgO—19.3%; Fe₂O₃—0.7%; Al₂O₃—2.6%; Na₂O—0.7%; K₂O—0.6%; P₂O₅—1.2%.

The melt is dispersed to drops with a size of 0.3-1.0 mm on a rotary tooth wheel. The spheres, cooled to 1000° C., were fed into a rotating cooler lined with chamotte brick and cooled during 12 minutes to a temperature of 950° C. After being cooled, the proppants were dispersed to fractions 30/50, 20/40 and 16/30. The properties of the proppants are presented in Table 1.

### EXAMPLE 2

The mixture, consisting of serpentinite, quartz-feldspar sand and apatite, was melted in an electric arc furnace at a temperature of 1500° C., dispersed to drops having a size of 0.2-0.8 mm by blowing with compressed air at a pressure of 9-11 atm through a U-shaped atomizer. After cooling in a drum cooler to a temperature of 20° C. the glass spheres were dispersed to fractions 40/70, 30/50 and 20/40, which were subjected to thermal treatment (retention) in a rotary furnace at a temperature of 1100° C. for 8 minutes. The chemical composition of the material: SiO₂—55.81%; MgO—29.64%; FeO—4.10%; Fe₂O₃—2.15%; Al₂O₃—3.87%; CaO—1.70%; P₂O₅—0.89%. Na₂O—0.70%; K₂O—0.56%; Cr₂O₃—0.48%; TiO₂—0.10%. The properties are presented in table 1.

### EXAMPLE 3

A mixture consisting of brucite, clay and magnesium borate were melted in an induction furnace at a temperature of 1550° C. in a graphite crucible, the melt was poured into a water-cooled iron mold and cooled during 15 minutes to a temperature of 20° C. The glass was crushed and the 0.4-0.9 mm fraction sieved. The chemical composition of the material: SiO₂—50.90%; MgO—23.06%; Al₂O₃—18.00%; B₂O₃—2.83%; K₂O—0.27%; Na₂O—0.71%; TiO₂—1.49%; Fe₂O₃—2.74%.

The glass powder was fed with air into the burner flame of a rotary furnace. Melting (spheroidization) of the particles took place in the burner flame, then the glass-spheres flew through the furnace, cooled to a temperature of 900° C., moving through the furnace were subjected to crystallization during 17 minutes at this temperature. The properties of the proppants are presented in table 1.

### EXAMPLE 4

Dolomitized limestone, clay and apatite were crushed with water in a ball mill, the suspension was dried in an atomizing drier and the powder granules with a size of 0.4-0.9 mm were treated in a manner similar to example 3 (melting in the burner flame of a rotary furnace at 1350° C., thermal treatment at 850° C. for 15 minutes). The chemical composition of the material: SiO₂—46.72%; CaO—22.75%; Al₂O₃—14.83%; MgO—9.34%; P₂O₅—2.07%; Fe₂O₃—1.96%; K₂O—0.39%; Na₂O—0.58%; TiO₂—1.36%. The properties of the proppants are presented in table 1.

The phase composition of the crystallized materials was determined by X-ray phase analysis, the fraction of the crystalline phase—by microanalysis according to the areas at the cut of the proppant. The apparent density, resistance to acids and impact resistance were determined according to ISO 13053. The properties of the proppant fraction 20/40 are presented in table 2.

An analysis of tables 1 and 2 shows that the claimed method makes it possible to produce proppant with enhanced operating characteristics as compared with known.

The compositions of the glass that are presented in the examples do not limit the proposed method, it also being possible to use other materials—high-silicon, lithium-containing, zinc-containing, but this is not always economically justified. During the production of proppant in accordance with the proposed method, the main crystalline phases are: pyroxene, diopside, wollastonite, clinoenstatit, cordierite, sapphirine, quartz, cristobalite, mullite, corundum, anorthite, spinel, rutile, magnesium titanate, aluminum titanate, magnesium ferrite, magnetite, chromospinel, augite and others, wherein the priority thereof is determined not only by the composition of the glass, but also by the regimens of thermal treatment.

TABLE 1
Properties of proppants

| | | | | | Part of | |
|---|---|---|---|---|---|---|
| | | | | | destroyed | |
| | | | | | granules, | |
| | Main | Fraction of | Apparent | | % at loads, | |
| | crystalline | crystalline | density, | Acid | PSi | |
| Proppant | phases | phases, % | g/cm³ | resistance % | 5000 | 10000 |
| Example 1 | diopside | More than | 1.68 | 2.7 | 0.3 | 3.3 |
| | | 90 | | | | |
| Example 2 | pyroxene | More than | 1.61 | 3.9 | 0.7 | 4.3 |
| | | 55 | | | | |
| Example 3 | cordierite, | More than | 1.58 | 2.8 | 0.2 | 3.1 |
| | sapphirine | 80 | | | | |
| Example 4 | diopside, | ~50 | 1.64 | 5.1 | 1.4 | 6.4 |
| | anorthite | | | | | |
| Glass-spheres | — | — | 1.50 | 11.4 | 1.9 | 19.8 |
| sodium-calcium- | | | | | | |
| silicate glass | | | | | | |
| Glass-spheres | — | — | 1.52 | 9.7 | 1.5 | 17.4 |
| high-strength | | | | | | |
| glass | | | | | | |

TABLE 2
Properties of glass-crystalline proppants

| Proppant | | Permeability, | |
|---|---|---|---|
| fraction | Sphericity and | Darsy, at | Conductance, md-f, at |
| 20/40 | roundness | pressure of 5000 PSi | pressure of 5000 PSi |
| Example 1 | 0.95/0.95 | 520 | 8100 |
| Example 2 | 0.93/0.95 | 470 | 7730 |
| Example 3 | 0.97/0.95 | 490 | 7950 |
| Example 4 | 0.93/0.95 | 430 | 7620 |

1. A method of producing proppant from glass spheres, comprising preparing a melt of oxides with forming spheres and cooling them, characterized in that the obtained spheres are additionally retained at 870-1100° C. for 8-25 minutes to the formation of a glass crystalline structure.

2. The method according to claim 1, characterized in that the glass crystalline structure comprises at least 40% crystalline phase.

3. The method according to claim 1, characterized in that the preparation of said melt is carried out by feeding glass powder in a gas stream.

4. The method according to claim 1, characterized in that said cooling and retention are carried out in one thermal device.

5. The method according to claims 1-4, characterized in that it is carried out in a rotary furnace.
